(19) United States
(12) Patent Application Publication
(10) Pub. No.: US 2010/0328068 A1
(43) Pub. Date: Dec. 30, 2010

(54) Hand-Held Pocket-Sized Barrier Penetrating Motion Detector

(76) Inventor: Robert Edward Schreiner, San Diego, CA (US)

Correspondence Address: ERIC HANSCOM, 2141 Palomar Airport Road, Suite 320, CARLSBAD, CA, 92011, US

(21) Appl. No.: 11/925,311

(22) Filed: Oct. 26, 2007

(51) Int. Cl. G08B 13/18; H01M 10/46

(52) U.S. Cl. 340/554; 320/101

(57) ABSTRACT

A motion detector utilizing a low microwave frequency that penetrates dry, non-metallic barriers and detects motion by sensing a Doppler shift in the received signal that has been reflected off of aqueous or metallic objects is disclosed. It is a battery powered hand-held pocket-sized device that includes a microwave motion sensing module that preferably operates continuously at a single frequency, with a single antenna for both transmitting and receiving microwave signals. Circuitry converts the Doppler shift in the received signal into a voltage that is then modified so that it can be immediately displayed to the user on an indicator meter. It is also contemplated that the device include a data logging module for storing the modified signal, another type of data, or both. The device can also include a means for charging the batteries and an on-off switch to conserve power while the device is not in use.

### STATEMENT REGARDING FEDERALLY SPONSORED RESEARCH OR DEVELOPMENT

This invention was federally sponsored.

### CROSS REFERENCE TO RELATED APPLICATIONS

None.

### BACKGROUND OF THE INVENTION

### Field of the Invention

This invention relates to the general field of radar systems and more specifically toward a motion detector utilizing low frequencies that penetrate dry, non-metallic barriers and detects motion by sensing a Doppler shift in the received signal that has been reflected off of aqueous or metallic objects. It is a battery powered hand-held pocket-sized device that includes a microwave motion sensing module that preferably operates continuously at a single frequency, with a single antenna for both transmitting and receiving microwave signals. Circuitry converts the Doppler shift in the received signal into a voltage that is then modified so that it can be immediately displayed to the user on an indicator meter. It is also contemplated that the device include a data logging module for storing the modified signal, another type of data, or both. The device can also include a means for charging the batteries and an on-off switch to conserve power while the device is not in use.

There are many situations where it would be beneficial to know whether or not there is motion behind a visually opaque barrier. Emergency personnel could quickly determine whether an adjacent room contains occupants simply by detecting whether or not there is gross human motion in the adjacent room. For example, the presence of a hostile individual could be determined before entering a room. It is preferable to have a device that operates in real time and is portable, small, and easy to use in these stressful situations.

The prior art has several examples of devices that can detect motion behind barriers, such as walls, fog, mist, or other non-metallic opaque barriers. U.S. Pat. No. 7,199,749 to Greneker, III et al., discloses a system and method for detecting respiratory rates of living individuals behind barriers. Greneker, III et al. teaches a device that comprises a homodyne Doppler radar module that generates a continuous microwave signal at 10.525 GHz. This signal travels to the barrier, such as a wall, where most of the signal is absorbed or reflected off of the barrier back to the device. Although greatly attenuated, a small portion of the signal passes through the barrier and falls incident upon objects, such as a living, breathing individual, which is then reflected back to the device. The motion of the individual's body causes a phase shift, frequency shift, or both, in the reflected signal proportional to the amount of motion towards or away from the device. A reference signal is mixed with the received signal, filtered, and amplified before it is fed to a signal processor, and then displayed to the user. Greneker, III et al, however, uses 10.525 GHz signals, a relatively high microwave frequency, in an effort to resolve, and thus detect, small movements such as respiration. This higher frequency does not penetrate barriers as well as lower frequency signals. To compensate for the attenuated signal, there is a significant increase in power requirements to sense motion behind the barrier. Greneker, III et al uses a very narrow antenna beam pattern of 16 degrees and can only detect respiratory motion within 10 feet of an 8-inch thick wall. While technically portable, the device disclosed in Greneker, III et al weighs 7 pounds and is by no means pocket sized. Further, significant signal processing is required to detect a small amount of motion, such as the target's respiration, while filtering out incidental motion imparted by the user holding the device. Without this additional level of signal processing, the device could not be considered “hand-held.”

U.S. Pat. No. 7,148,836 to Romero et al., discloses a radar system that detects, tracks and creates an image of an individual, animal, or object behind a barrier. It uses a multiplicity of low-powered ultra wideband radar units. These units collect large amounts of data that must be processed to create a usable output, which, in this instance, can be video displayed at rates of 30 frames per second. While the unit is lightweight and portable, it is not pocket sized nor is it inexpensive to manufacture, and requires significant signal processing.

U.S. Pat. No. 6,466,155 to Taylor et al., teaches an apparatus for detecting a moving object that is located behind a barrier. This patent also uses a multiplicity of radar units. Full waveform signals are detected by the radar units and then processed, digitized, background noise cancelled out, and then graphically displayed to the user. Taylor, as with Romero, does not provide for an inexpensive, pocket sized unit.

U.S. patent application Ser. No. 10/589,473, to Zemany et al., also discloses a device to detect the motion of objects behind a wall. The phase difference between two continuous wave signals is determined, and a change in the phase difference is correlated to movement behind the wall. It is portable and battery powered, but detects motion behind a wall by sensing a phase difference of a 900 MHz signal. FCC-approved off-the-shelf microwave motion sensing modules usually operate at center frequencies of 2.45 GHz, 5.8 GHz, 10.525 GHz, or 24.125 GHz. The frequency of 900 MHz is generally reserved for radio communications, and is not approved as a motion detection frequency in locations such as Europe.

Thus there has existed a long-felt need for a device that can detect motion behind a dry, non-metallic barrier, such as a wall or door, that is small enough to fit into a pocket. It should be portable, preferably battery powered, and can be used quickly and easily to determine whether or not gross motion is present behind an otherwise visually opaque barrier. The device should also be inexpensive so that it is affordable for an organization, such as a local police department, to own multiple motion detecting devices, as well as affordable for the individual consumer.

The current invention provides just such a solution by having a motion detector utilizing low frequencies that penetrate dry, non-metallic barriers and detects motion by sensing a Doppler shift in the received signal that has been reflected off of aqueous or metallic objects. It is a battery powered hand-held pocket-sized device that includes a microwave motion sensing module that preferably operates continuously at a single frequency, with a single antenna for both transmitting and receiving microwave signals. Circuitry converts the Doppler shift in the received signal into a voltage that is then modified so that it can be immediately displayed to the user on an indicator meter. It is also contemplated that the device include a data logging module for storing the modified signal, another type of data, or both. The device can also include a means for charging the batteries and an on-off switch to conserve power while the device is not in use.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### SUMMARY OF THE INVENTION

The current invention is a motion detector, that can detect motion behind a dry, non-metallic barrier. It comprises a microwave motion sensing module, a signal processor circuit, and an indicator meter. It is battery powered, and these batteries can optionally be charged by solar power-generating cells. The device can also include a means for logging the signal from the signal processor, and a means for triggering when the signal from the processor should be logged. Finally, there is an on-off switch to conserve battery power when the unit is not needed.

The microwave motion sensing module has a loop antenna that preferably transmits a wave at a frequency of 2.45 GHz, which is in the S-band of frequencies. The S-band of frequencies, between 2 GHz and 4 GHz, easily penetrate through dry, non-metallic walls to detect gross human movements without excessive power requirements. The choice in frequency represents a tradeoff: higher frequencies generally require a more powerful signal to penetrate the wall, while lower frequencies are not able to detect small movements. Lower frequencies, however, are easily reflected off of objects that are made of metal, such as cars, or water, such as humans. It is also contemplated by the inventor that the device could operate in the C-band of frequencies, which are between 4 GHz and 8 GHz. For example, if the S-band of frequencies is unavailable because it is reserved for law enforcement, a frequency in the C-band, such as 5.8 GHz, could be used to achieve the same purpose: barrier penetration to detect motion. Conversely, a lower frequency could be used, such as 900 MHz, if the C-band was also unavailable.

It is important to note, however, that the current invention can detect motion behind barriers even if the barrier is slightly moist or contains thin metal. The frequencies contemplated by the inventor to be used by the device can penetrate through a wall that is slightly moist, such as a wall with some condensed moisture on its outer portion. Also, the penetrating strength of these frequencies allows the detector to retain its utility against walls containing small amounts of metal, such as foil-thin metal, rebar, or chicken wire. When this document references dry, non-metallic barriers, or barriers generally, it is meant to include mostly dry, and mostly non-metallic barriers.

The loop antenna allows for a broad beam to detect motion in a larger area. There are, however, many other types of antenna that can be used to detect motion behind a visually opaque barrier. Different uses of the device may also render different antennae type more beneficial. For example, the motion detecting device may be intended to detect motion in a small, narrow field of vision, and therefore a directional antenna as opposed to a loop antenna would be preferable. Indeed, there are a multiple number of off-the-shelf antenna, as well as frequency, variations that could be used to achieve the goal of the device: to detect motion behind a visually opaque, dry, non-metallic, barrier using a handheld, inexpensive device.

The microwave motion sensing module senses motion by employing the Doppler shift phenomenon, which is well understood from acoustic and electro-magnetic wave theory. A low-frequency microwave signal is transmitted from the microwave module's antenna. The signal is then reflected of off aqueous or metallic objects located behind the barrier, passed back through the barrier, and received by the antenna in the microwave motion sensing module. This return signal is used to determine whether there are objects in the room that are in motion, such as a person walking or handling a firearm. Under the principles of Doppler, a small change in the frequency of the signal received by the antenna indicates that motion is present in the room. A higher frequency shift represents an object that is moving towards the device, while a lower frequency shift represents an object that is moving away from the device. The circuitry in the microwave motion sensing module converts the frequency shift in the reflected signal into a voltage.

The voltage from the microwave motion sensing module is then modified by a signal processor circuit designed by the inventor. The signal processor circuit modifies the voltage using various simple electronic components, such as resistors and capacitors, to an appropriate voltage in accordance with the input requirements of the indicator meter. Various combinations of resistors, capacitors, and other simple electronic components can be used to achieve the appropriate voltage, and are well known by persons of ordinary skill in the art. The indicator meter then displays whether or not the microwave motion sensing module has sensed any movement and to what extent. This information can be displayed in real time to the user. Optionally, the indicator meter can also display whether the object is moving away from or towards the device. A simple LCD indicator meter is contemplated by the inventor because of its reliability and low power consumption.

The motion detector can also include a data logging module, where this module records the voltage sent to the indicator meter. The data logging module collects and stores the voltage sent from the signal processor over a period of time such that the user can retrieve and view this data after it has been recorded. The data logging module can also completely replace the indicator meter. In this embodiment, the motion detector is used to record when motion occurs, and to what extent, over a period of time. In another embodiment, a timing device is included with the data logging module. The voltage sent from the microwave motion sensing module can cause the data logging module to record data, where this data is not only the voltage from the microwave motion sensing module, but also the time that it occurred. In other words, motion that is detected above a set threshold triggers the data logging module to record the amount of motion that was sensed and when it occurred. It is contemplated that a minimum voltage, corresponding to a minimum amount of motion, is required to trigger the data logging module to begin recording. The data logging module could continue to record until the motion stops or for a set period of time depending on the wishes of the user, or simply record the time stamp of the triggering motion. It is also possible to have the data logging module record other information when it is triggered, such as audio from a microphone or video from a camera. The motion detector, therefore, can give reliable readouts of information, including when the device detected motion, and to what extent, without unnecessarily using power or recording media.

A microwave absorbing material, a microwave reflecting metal, or both can also be included with the current invention. For example, an absorbent elastomer with a reflecting metal ground plane can be used to shape the effective beam pattern of the antenna, reduce antenna side and back-lobes, shield the antenna and circuit from high-frequency interference, and shield the antenna from detecting unwanted or incidental operator motion. One such elastomer is the Laird Technologies “Q-Zorb” Material. Product number 1060 is tuned to produce a 20 dB loss at a frequency of 2.4 GHz, uses natural rubber as the material substrate, and has a self-adhesive backing

When the motion detector is intended to be used in the field, a remote paging module can be used to remotely alert the user that motion has been detected. A remote paging module, similar to one commonly used with car and motorcycle alarm systems, can be incorporated into the motion detector. This will allow the user to be alerted that the motion detector has detected motion, without looking directly at the motion detector. A user could, therefore, be located hundreds of yards away, depending on the range of the remote paging device, and be notified when the motion detector detects motion.

One specific embodiment of the invention contemplated by the inventor uses a microwave motion sensing module similar to the one used in the S-band Intellisense® DT500 Dual-Tec® intrusion detector for security systems. A voltage signal that is proportional to the sensed motion is taken from the microwave motion module and is further processed by the signal processor circuit, which in this embodiment is a low-pass RC filter and divider that results in a direct current voltage between zero and one volts. This direct current voltage between zero and one volts can be fed into a simple LCD needle meter, such as a model QM-130M manufactured by Martel Electronics. This needle meter is mounted on the outside of a small enclosure. The voltage can also be fed into a data logging module, such as an OMEGA® NOMAD® OM-50 Series data logger. A standard nine volt battery is included inside of the enclosure as well to power the system. All of these components can be placed in a Hammond Manufacturing's 1599EBKBAT enclosure that measures 6.69 inches by 3.37 inches by 1.38 inches.

It is a principal object of the invention to provide a device for detecting gross motion behind a dry, non-metallic barrier such as a wall, door, or covered window.

It is another object of the invention to provide a device for detecting motion that is portable and battery powered.

It is an additional object of the invention to provide a device for detecting motion that is simple and easy to use.

It is a final object of this invention to provide a device for detecting motion that is small in size such that it can be held in the users hand and fit into a pocket.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

FIG. 1 is a back-top perspective view of the motion detector in the hand of the user.

FIG. 2 is a front-top perspective view of the motion detector with a partial cut-away on the front side to view the internal wire-loop antenna.

FIG. 3 is a schematic view of an embodiment of the motion detector.

FIG. 4 is a schematic view of another embodiment of the motion detector with a data logging module.

FIG. 5 is a view of an individual surreptitiously exiting a room.

FIG. 6 is a view of an individual traveling surreptitiously outdoors through an open area.

### DETAILED DESCRIPTION OF THE FIGURES

Many aspects of the invention can be better understood with reference to the drawings below. The components in the drawings are not necessarily drawn to scale. Instead, emphasis is placed upon clearly illustrating the components of the present invention. Moreover, like reference numerals designate corresponding parts through the several views in the drawings.

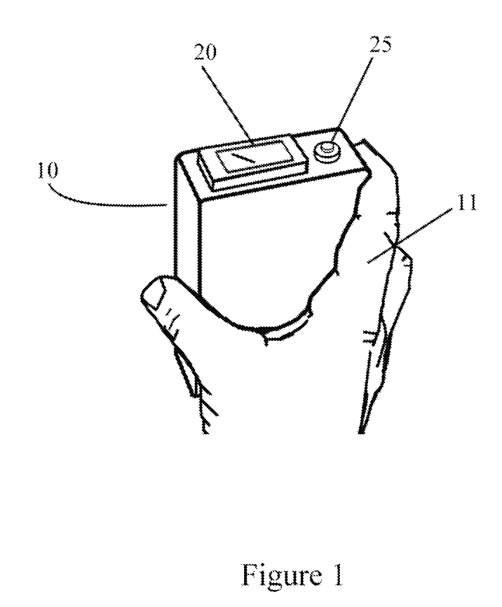

FIG. 1 is a back-top perspective view of the motion detector in the hand of the user. The motion detector 10 is located in the hand of the user 11. The motion detector 10 includes an indicator meter 20 and an on-off switch 25, both located at the top of the device. The indicator meter 20 gives an indication to the user as to whether or not there is motion located behind an opaque barrier. The indication to the user can occur immediately after the motion detector 10 senses motion.

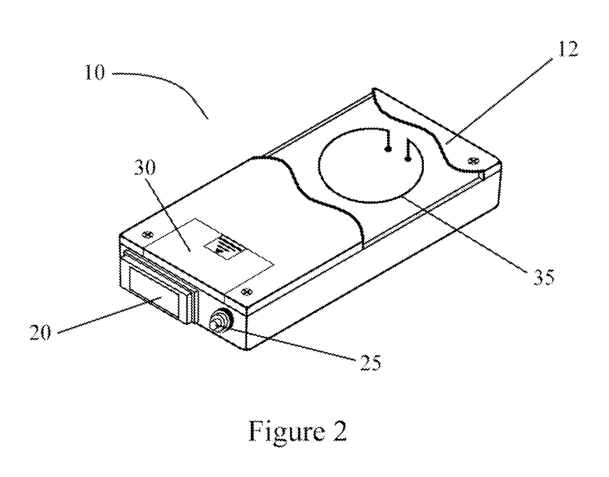

FIG. 2 is a front-top perspective view of the motion detector with a partial cut-away on the front side to view the internal wire-loop antenna. The motion detector 10 has an enclosure 12. The enclosure 12 has a battery cover 30 behind which lies a battery (not shown). At the top of the motion detector 10 is an indicator meter 20 and an on-off switch 25. Inside of the enclosure 12 is an antenna 35.

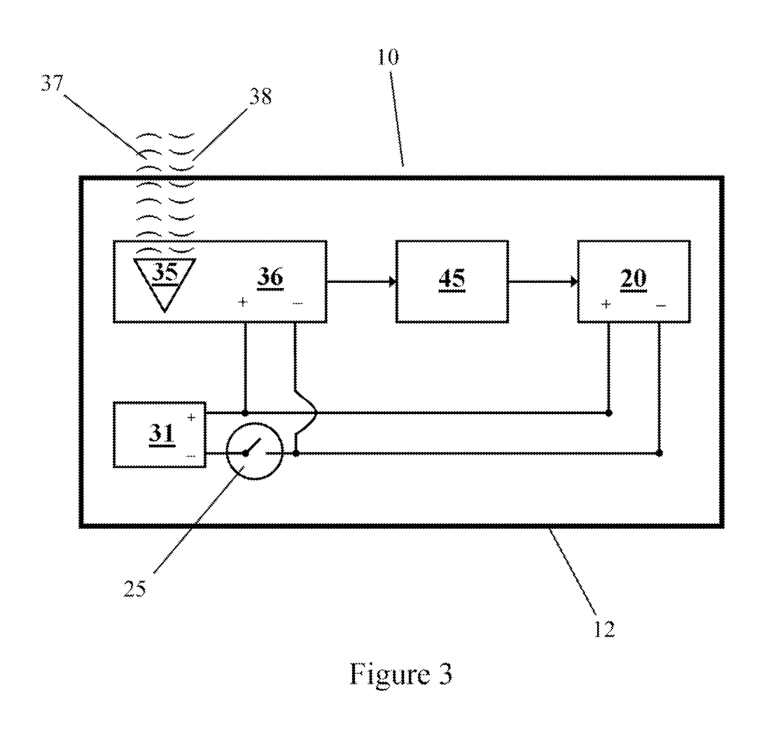

FIG. 3 is a schematic view of an embodiment of the motion detector. A microwave motion sensing module 36 is located inside of an enclosure 12. A transmitted signal 37 leaves the antenna 35 of the microwave motion sensing module 36 and travels out of the motion detector 10. This transmitted signal reflects off of an object (not shown) and returns to the motion detector as a reflected signal 38. This reflected signal 38 is received by the antenna 35. The frequency of the reflected signal 38 depends on whether it is reflected off of a moving or stationary object, and if it is reflected off of a moving object, then the rate at which the object is moving toward or away from the motion detector 10. This phenomenon is known as a Doppler shift. The frequency of the reflected signal 38 is converted into a voltage. The voltage is then sent to a signal processor circuit 45. The signal processor circuit 45 modifies the voltage so that the modified voltage can be read by the display indicator 20. The display indicator 20 then shows the user whether an object behind a barrier is moving. A battery 31 is included in the motion detector 10 to power the various electrical components of the device. Finally, there is an on-off switch 25 which disconnects the battery 31 from the various electrical components such that the battery 31 is not unnecessarily drained when the motion detector 10 is not in use.

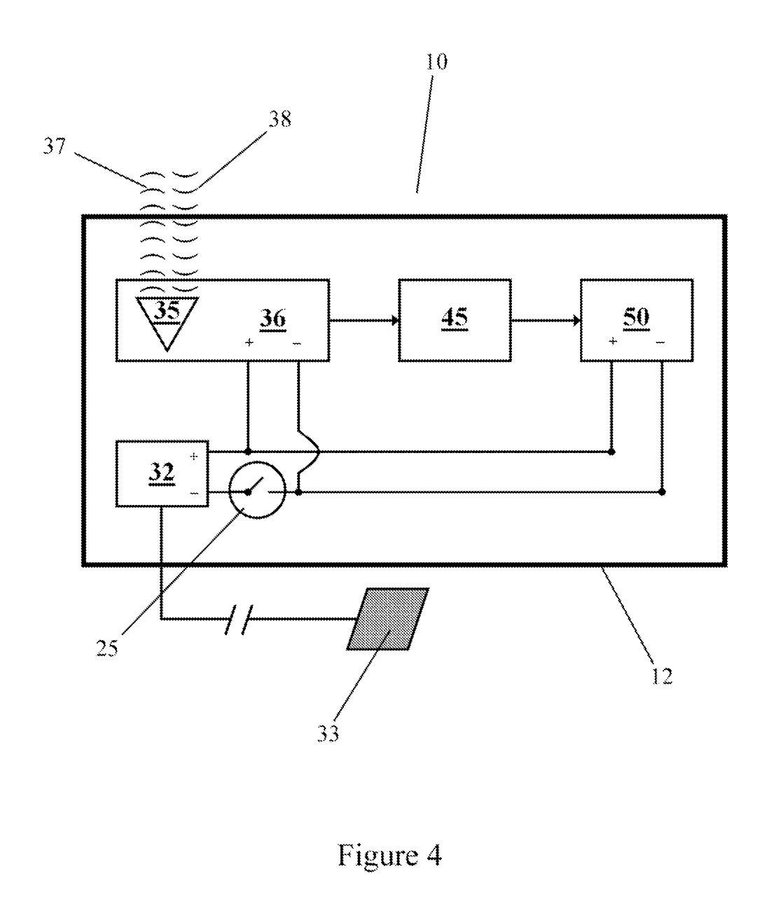

FIG. 4 is schematic view of another embodiment of the motion detector with a data logging module. A microwave motion sensing module 36 is located inside of an enclosure 12. A transmitted signal 37 leaves the microwave motion sensing module 36 and travels out of the motion detector 10. This transmitted signal reflects off of an object (not shown) and returns to the motion detector as a reflected signal 38. This reflected signal 38 is received by the antenna 35. The frequency of the reflected signal 38 depends on whether it is reflected off of a moving or stationary object, and if it is reflected off of a moving object, then the rate at which the object is moving toward or away from the motion detector 10. This phenomenon is known as a Doppler shift in frequency. The change in frequency of the reflected signal 38 is converted into a voltage. The voltage is then sent to a signal processor circuit 45. The signal processor circuit 45 modifies the voltage so that the modified voltage can be read into and recorded by a data logger 50. The data logger 50 records the signal produced by the signal processor circuit 45 such that the data collected can be retrieved by the user to be viewed at a later date. The data logger 50 can record data continuously. Alternatively, the data logger 50 can record data only when it receives a signal from the signal processor circuit 45 indicating that the microwave motion sensing module 36 senses motion. This data can be recorded with a timestamp such that the user can view the data and determine at what point in time the motion detector 10 detected motion and how much motion was detected. A rechargeable battery 32 is included in the motion detector 10 to power the various electrical components of the device. The rechargeable battery 32 can, in turn, be connected to a solar panel 33 or other power source. The solar panel 33 or other power source will then recharge the rechargeable battery 32 allowing for much longer periods of continuous use. Finally, there is an on-off switch 25 which disconnects the battery 32 from the various electrical components such that the battery 32 is not unnecessarily drained when the motion detector 10 is not in use.

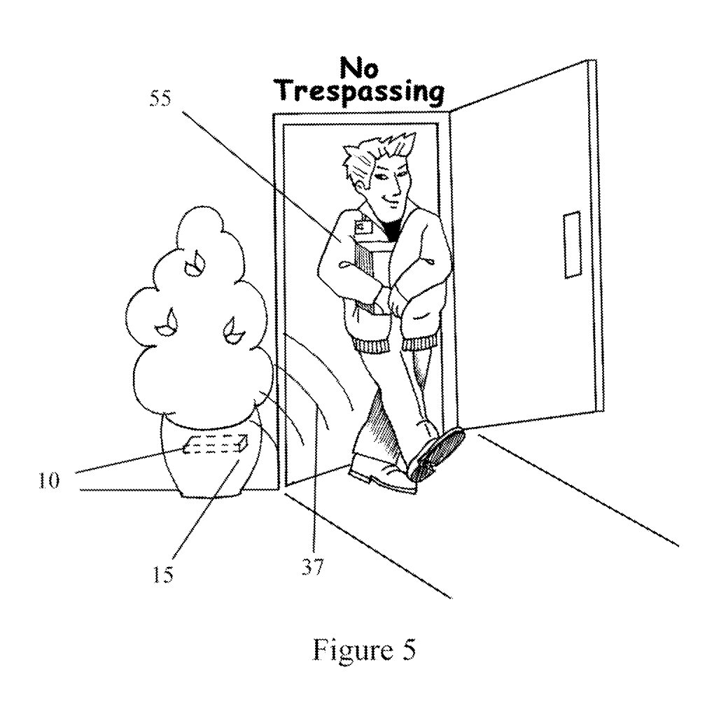

FIG. 5 is a view of an individual surreptitiously exiting a room. A motion detector 10 is hidden behind a dry, non-metallic barrier 15, which in this figure is a dry, fake potted plant. A transmitted signal 37 leaves the motion detector 10 and is used to sense moving objects, such as an individual 55 exiting a room.

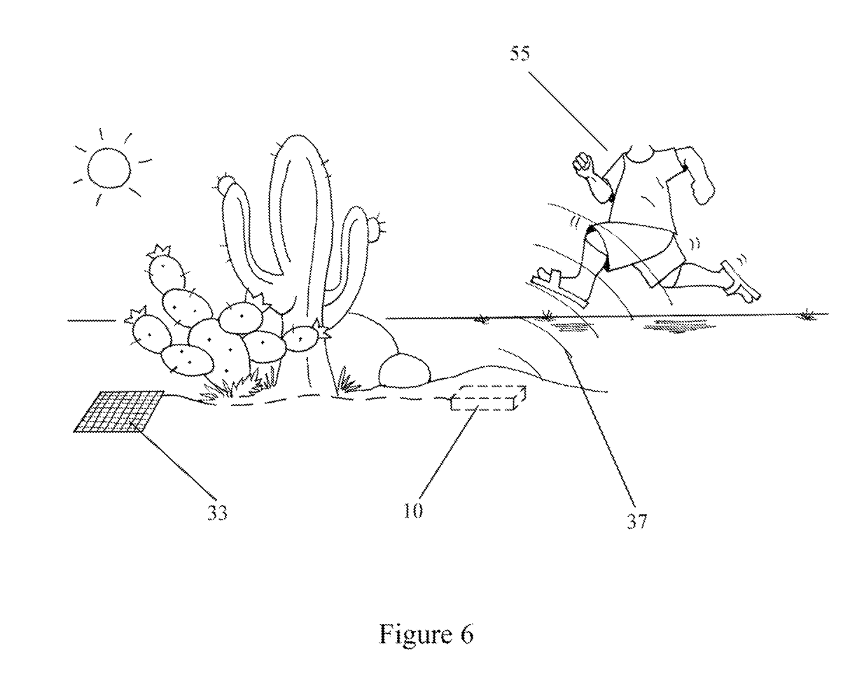

FIG. 6 is a view of an individual traveling surreptitiously outdoors through an open area. A motion detector 10 hidden behind a barrier. In this figure, the motion detector is buried in the dry ground. A transmitted signal 37 leaves the motion detector 10 and is used to sense moving objections, such as an individual 55 moving through an open area. A solar panel 33 is connected to the motion detector 10. The solar panel 33 is used to power and recharge the battery of the motion detector 10 for extended periods of time.

What I claim is:

1. A device for detecting motion behind an visually opaque barrier comprising
a microwave motion sensing module, where the microwave motion sensing module comprises an antenna, where the microwave motion sensing module transmits a signal that will penetrate through a dry, non-metallic opaque barrier and reflect off of metallic or water based objects, where the reflected signal is received by the antenna of the microwave motion sensing module, where the microwave motion sensing module senses motion as a Doppler frequency shift in the return signal and produces a voltage that is proportional to the motion that it detects,
a signal processor circuit, where the signal processor circuit comprises resistors, capacitors, or both, where the signal processor circuit receives a voltage from the microwave motion sensing module and produces a second voltage that is proportional to the voltage from the microwave motion sensing module,
an indicator meter, where the indicator meter receives the second voltage from the signal processor and, based upon this voltage, conveys to an individual viewing the indicator meter the amount of motion detected by the microwave motion sensing module, and
a battery, where the battery supplies power to at least the microwave motion sensing module.

2. The device of claim 1, further comprising an on-off switch, where the battery is disconnected from and supplies no power to the microwave motion sensing module when the switch is in the off position, and the battery is connected and supplies power to the microwave motion sensing module when the switch is in the on position.

3. The device of claim 1, further comprising a means for recording the voltage produced by the signal processor circuit, where the recorded voltage can be retrieved and displayed to the user after it has been recorded.

4. The device of claim 3, where the means for recording the voltage produced by the signal processor circuit only records the voltage when the microwave motion sensing module detects motion.

5. The device of claim 4, where the time and date is also recorded with the voltage produced by the signal processor circuit.

6. The device of claim 1, where the signal that is transmitted from the microwave motion sensing module has a frequency greater than 2 GHz and less than 4 GHz.

7. The device of claim 1, where the signal that is transmitted from the microwave motion sensing module has a frequency greater than 4 GHz and less than 8 GHz.

8. The device of claim 1, where the indicator meter can further display whether the motion of the object is towards the device or away from the device.

9. The device of claim 1, where the indicator meter can further display the absolute motion of the object regardless of whether the object is moving toward or away from the device.

10. The device of claim 1, where the voltage produced by the battery is approximately 9 volts or less.

11. The device of claim 1, where the battery is a rechargeable battery.

12. The device of claim 11, where the battery can be connected to a solar panel, where this solar panel can recharge the battery.

13. The device of claim 1, further comprising a microwave absorbing material, a microwave reflecting material, or both.

14. The device of claim 1, further comprising a means to remotely alert the user, such that the user can be alerted when the device detects motion without directly viewing the device.

15. The device of claim 1, where the device can fit inside of a box measuring 7 inches by 4 inches by 2 inches.

16. A device for detecting motion behind a visually opaque barrier comprising
a microwave motion sensing module, where the microwave motion sensing module comprises an antenna, where the microwave motion sensing module transmits a signal that will penetrate through a dry, non-metallic opaque barrier and reflect off of metallic or water based objects, where the reflected signal is received by the antenna of the microwave motion sensing module, where the microwave motion sensing module senses motion as a Doppler frequency shift in the return signal and produces a voltage that is proportional to the motion that it detects,
a signal processor circuit, where the signal processor circuit comprises resistors, capacitors, or both, where the signal processor circuit receives a voltage from the microwave motion sensing module and produces a second voltage that is proportional to the voltage from the microwave motion sensing module,
a means for recording the voltage produced by the signal processor circuit, where the recorded voltage can be retrieved and displayed to the user after it has been recorded, and
a battery, where the battery supplies power to at least the microwave motion sensing module.

17. The device of claim 16, further comprising an on-off switch, where the battery is disconnected from and supplies no power to the microwave motion sensing module when the switch is in the off position, and the battery is connected and supplies power to the microwave motion sensing module when the switch is in the on position.

18. The device of claim 16, where the means for recording the voltage produced by the signal processor circuit only records the voltage when the microwave motion sensing module detects motion.

19. The device of claim 16, where the time and date is also recorded with the voltage produced by the signal processor circuit.

20. The device of claim 16, where the signal that is transmitted from the microwave motion sensing module has a frequency greater than 2 GHz and less than 4 GHz.

21. The device of claim 16, where the signal that is transmitted from the microwave motion sensing module has a frequency greater than 4 GHz and less than 8 GHz.

22. The device of claim 16, where the voltage produced by the battery is approximately 9 volts or less.

23. The device of claim 16, where the battery is a rechargeable battery.

24. The device of claim 23, where the battery can be connected to a solar panel, where this solar panel can recharge the battery.

25. The device of claim 16, where the device can fit inside of a box measuring 7 inches by 4 inches by 2 inches.

26. The device of claim 16, further comprising a microwave absorbing material, a microwave reflecting material, or both.

27. A device for detecting motion behind a visually opaque barrier comprising
a microwave motion sensing module, where the microwave motion sensing module comprises an antenna, where the microwave motion sensing module transmits a signal that will penetrate through a dry, non-metallic opaque barrier and reflect off of metallic or water based objects, where this signal has a frequency of 2.45 GHz, where the reflected signal is received by the antenna of the microwave motion sensing module, where the microwave motion sensing module senses motion as a Doppler frequency shift in the return signal and produces a voltage that is proportional to the motion that it detects,
a signal processor circuit, where the signal processor circuit comprises resistors, capacitors, or both, where the signal processor circuit receives a voltage from the microwave motion sensing module and produces a second voltage that is proportional to the voltage from the microwave motion sensing module,
an indicator meter, where the indicator meter receives the second voltage from the signal processor circuit and, based upon this voltage, conveys to an individual viewing the indicator meter the amount of motion detected by the microwave motion sensing module,
a battery, where the battery supplies power to at least the microwave motion sensing module and the voltage produced by the battery is approximately 9 volts or less,
an on-off switch, where the battery is disconnected from and supplies no power to the microwave motion sensing module when the switch is in the off position, and the battery is connected and supplies power to the microwave motion sensing module when the switch is in the on position, and
where the device can fit inside of a box measuring 7 inches by 4 inches by 2 inches.

28. The device of claim 27, where the indicator meter can further display whether the motion of the object is towards the device or away from the device.

29. The device of claim 27, further comprising a means for recording the voltage produced by the signal processor, where the recorded voltage can be retrieved and displayed to the user after it has been recorded.

30. The device of claim 27, further comprising a microwave absorbing material, a microwave reflecting material, or both.

31. The device of claim 27, further comprising a means to remotely alert the user, such that the user can be alerted when the device detects motion without directly viewing the device.
